(19) United States
(12) Patent Application Publication
(10) Pub. No.: US 2024/0194388 A1
(43) Pub. Date: Jun. 13, 2024

(54) COMPOSITE INDUCTOR

(71) Applicant: CHILISIN ELECTRONICS CORP., HSINCHU COUNTY (TW)

(72) Inventors: CHAU-CHYUN CHUNG, TAOYUAN CITY (TW); CHI-FENG LI, TAOYUAN CITY (TW); HSIN HSIEN YEH, TAOYUAN CITY (TW)

(21) Appl. No.: 18/317,891

(22) Filed: May 15, 2023

(30) Foreign Application Priority Data
Dec. 7, 2022 (TW) 111146852

(51) Int. Cl. H01F 27/255; H01F 27/28; H01F 41/02

(52) U.S. Cl. CPC H01F 27/255; H01F 27/28; H01F 41/0246

(57) ABSTRACT

A composite inductor includes a coil structure and a magnetic packaging structure. The coil structure has a through hole, and the coil structure is embedded in the magnetic packaging structure. The magnetic packaging structure contains at least a first magnetic body and a second magnetic body. Based on a total thickness of the magnetic packaging structure being 100%, a thickness of each of the first magnetic body and the second magnetic body is higher than or equal to 16%.

### CROSS-REFERENCE TO RELATED PATENT APPLICATION

This application claims the benefit of priority to Taiwan Patent Application No. 111146852, filed on Dec. 7, 2022. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a composite inductor, and more particularly to a composite inductor containing a plurality of magnetic bodies.

### BACKGROUND OF THE DISCLOSURE

An inductor is a passive component that is widely used in circuit design. The inductor can have various structures according to different applications. Taking a conventional inductor as an example, a coil is wound on a magnetic core, and the coil and the magnetic core are completely encapsulated by a packaging structure. Specifically, a conventional magnetic core has a substrate part and a pillar part that protrudes from the substrate part. The coil is wound on the pillar part, such that the pillar part can support a winding section of the coil. In addition, a non-winding section of the coil is fixed on the substrate part.

Due to continuous increase in functions of electronic devices, requirements for certain properties of the inductors are also increased. Therefore, how to reduce the DC resistance value of the inductors, with the inductors having the same inductance by improving the structural design of the inductors has become one of the important issues to be addressed in the industry.

### SUMMARY OF THE DISCLOSURE

In response to the above-referenced technical inadequacy, the present disclosure provides a composite inductor.

In one aspect, the present disclosure provides a composite inductor. The composite inductor includes a coil structure and a magnetic packaging structure. The coil structure has a through hole, and the coil structure is embedded in the magnetic packaging structure. The magnetic packaging structure contains at least a first magnetic body and a second magnetic body. Based on a total thickness of the magnetic packaging structure being 100%, a thickness of each of the first magnetic body and the second magnetic body is higher than or equal to 16%.

Therefore, in the composite inductor provided by the present disclosure, by virtue of “the magnetic packaging structure containing at least a first magnetic body and a second magnetic body,” and “based on a total thickness of the magnetic packaging structure being 100%, a thickness of each of the first magnetic body and the second magnetic body being higher than or equal to 16%,” properties of the composite inductor can be enhanced or modified.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective view of a composite inductor according to a first embodiment of the present disclosure;

FIG. 2 is a cross-sectional view of the composite inductor according to the first embodiment of the present disclosure;

FIG. 3 is a schematic perspective view of a coil structure according to the first embodiment of the present disclosure;

FIG. 4 is a schematic perspective view of the coil structure being mounted on a first magnetic body according to the first embodiment of the present disclosure;

FIGS. 5 to 7 are schematic views of steps for manufacturing the composite inductor according to the first embodiment of the present disclosure;

FIG. 8 is a cross-sectional view of a composite inductor according to a second embodiment of the present disclosure;

FIG. 9 is a cross-sectional view of a composite inductor according to a third embodiment of the present disclosure;

FIG. 10 is a cross-sectional view of a composite inductor according to a fourth embodiment of the present disclosure;

FIG. 11 is a cross-sectional view of a composite inductor according to a fifth embodiment of the present disclosure;

FIG. 12 is a cross-sectional view of a composite inductor according to a sixth embodiment of the present disclosure;

FIG. 13 is a cross-sectional view of a composite inductor according to a seventh embodiment of the present disclosure;

FIGS. 14 and 15 are schematic top views of steps for manufacturing a composite inductor according to an eighth embodiment of the present disclosure; and

FIG. 16 is a cross-sectional view of the composite inductor according to the eighth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

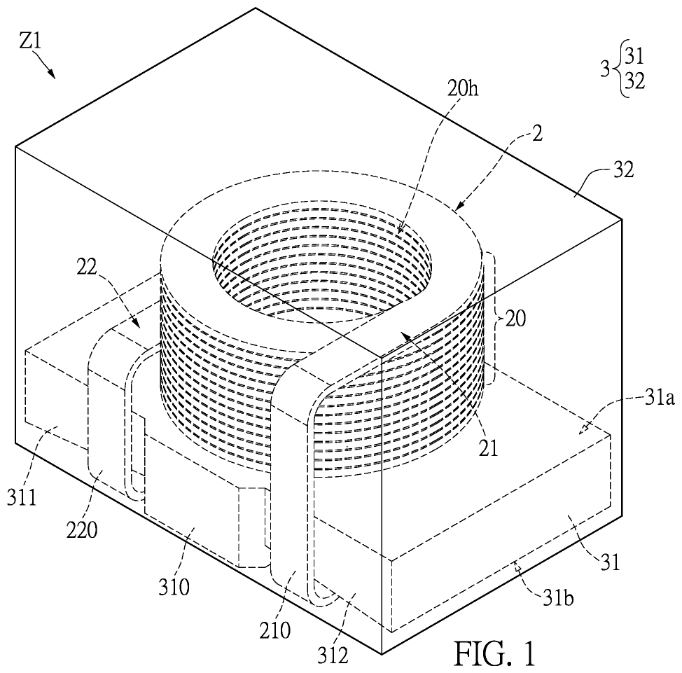

Referring to FIG. 1, a composite inductor Z1 of the present disclosure includes a coil structure 2 and a magnetic packaging structure 3. A part of the coil structure 2 is embedded in the magnetic packaging structure 3. The magnetic packaging structure 3 is formed from two or more than two types of magnetic bodies. In other words, the magnetic packaging structure 3 contains at least a first magnetic body 31 and a second magnetic body 32.

### First Embodiment

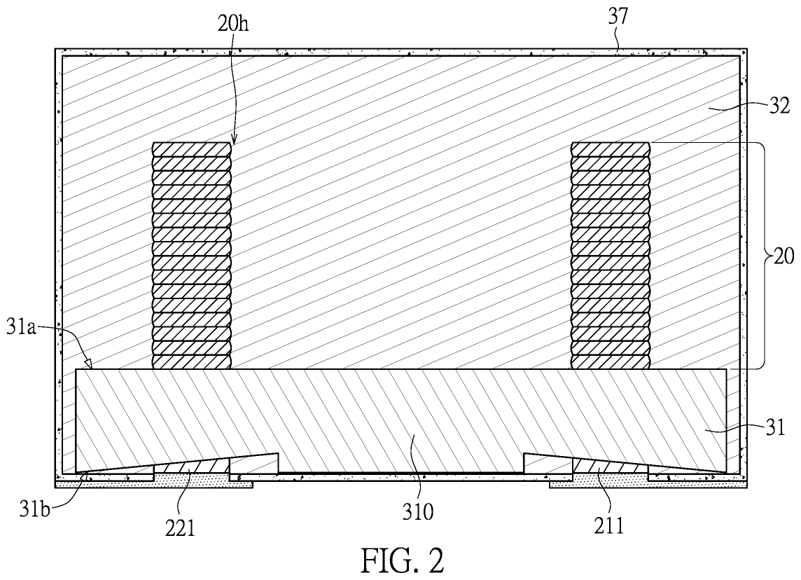

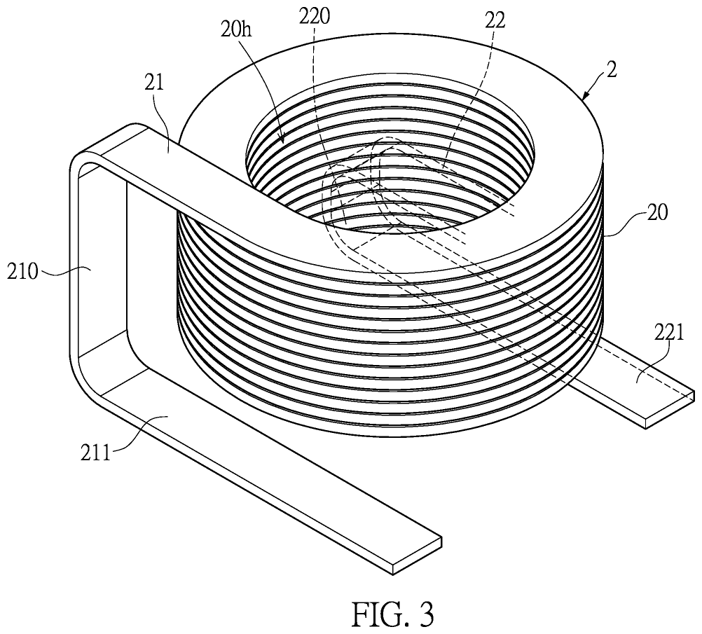

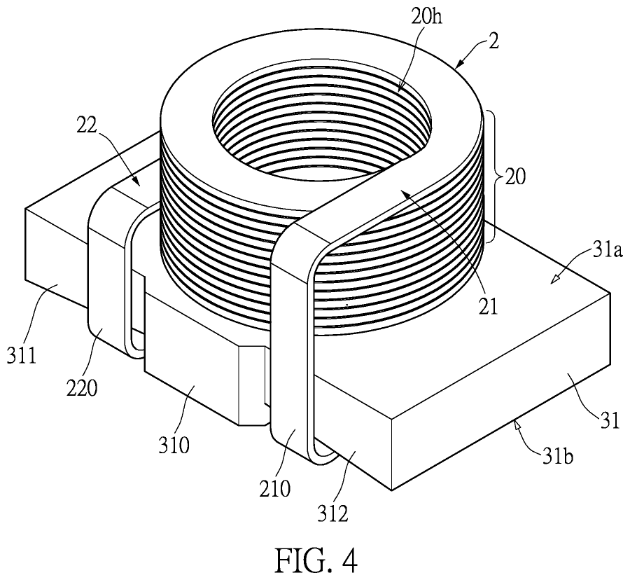

Referring to FIG. 1 to FIG. 4, FIG. 1 shows a schematic perspective view of the composite inductor according to a first embodiment of the present disclosure, FIG. 2 shows a cross-sectional view of the composite inductor according to the first embodiment of the present disclosure, FIG. 3 shows a schematic perspective view of the coil structure according to the first embodiment of the present disclosure, and the FIG. 4 shows a schematic perspective view of the coil structure mounted on the first magnetic body according to the first embodiment of the present disclosure.

The coil structure 2 includes a coil main body 20, a first extension section 21, and a second extension section 22. A conductive wire is wound along an axis to form the coil main body 20. For example, the conductive wire can be wound through a parallel winding or an alpha winding (also known as an outer winding). The coil main body 20 includes a plurality of turns, and a through hole 20h is surrounded by the plurality of turns. The aforementioned conductive wire can be a flat conductive wire or a round conductive wire, and can further include an outer insulation layer and an inner conductor. The figures are only for illustration purposes, and the present disclosure is not limited thereto.

Referring to FIG. 2 and FIG. 3, in the first embodiment, the first extension section 21 and the second extension section 22 are respectively two terminal sections of unwound parts of the conductive wire that do not form the turn. The first extension section 21 is connected with a top turn and includes a first bending section 210 and a first lead 211. The first bending section 210 extends from the top turn and is bent toward a first magnetic body 31. The first lead 211 extends from the first bending section 210 and is bent toward a bottom surface 31b of the first magnetic body 31. The second extension section 22 is connected with a bottom turn and includes a second bending section 220 and a second lead 221. The second bending section 220 extends from the bottom turn and extends along a mounting surface 31a of the first magnetic body 31. The second lead 221 extends from the second bending section 220 and is bent toward the bottom surface 31b of the first magnetic body 31. Therefore, the coil structure 2 can be assembled with the first magnetic body 31. However, the present disclosure is not limited thereto.

The first magnetic body 31 as shown in FIG. 1 can be used as a pillarless magnetic substrate. In other words, the mounting surface 31a of the first magnetic body 31 does not have any pillar part protruding therefrom. However, the present disclosure is not limited thereto. The first magnetic body 31 can also be a magnetic substrate that has a pillar part.

A mounting area for disposing the coil structure 2 is defined on the mounting surface 31a of the first magnetic body 31. The mounting area of the first magnetic body 31 can be a flat surface. In another embodiment, a groove can be formed on the mounting area, such that the coil structure 2 can be easily mounted on the first magnetic body 31.

The first magnetic body 31 includes a middle part 310 and two extension parts 311 and 312 connected with the middle part 310. The two extension parts 311 and 312 are respectively connected with two ends of the middle part 310 and extend along two opposite directions. In one exemplary embodiment, the two extension parts 311 and 312 have a wedge shape. Thicknesses of the two extension parts 311 and 312 are increased in a direction away from the middle part 310. In other words, thicknesses of inner sides of the extension parts 311 and 312 (i.e., the side near the middle part 310) are thinner than thicknesses of outer sides of the extension parts 311 and 312 (i.e., the side away from the middle part 310). In other embodiments, the two extension parts 311 and 312 can be rectangle-shaped, but are not limited thereto.

A material used for forming the first magnetic body 31 includes a magnetic powder and a binder material. The magnetic powder includes one of iron, iron-nickel alloys, iron-cobalt alloys, iron-silicon alloys, iron-vanadium alloys, iron-silicon-chromium alloys, iron-silicon-aluminum alloys, iron-cobalt-vanadium alloys, iron-based amorphous alloys, iron-based nanocrystalline alloys, nickel-zinc ferrite, nickel-copper-zinc ferrite, and manganese-zinc ferrite. The binder material can be an epoxy resin, a polysiloxane resin, an acrylic resin, a phenolic resin, or a polyvinyl alcohol.

By selection of the materials and controlling a particle size of the magnetic powder, the relative magnetic permeability of an overall magnetic body can be adjusted. Specific components of the magnetic body are listed in Table 1. Specifically, the material for forming the first magnetic body 31 includes one type of magnetic powder. The magnetic powder is the carbonyl iron powder that has a median diameter of ranging from 4 μm to 5 μm. Based on a total weight of the magnetic powder being 100 phr (parts per hundreds of resin), an amount of the binder material ranges from 1 phr to 6 phr; preferably, the amount of the binder material ranges from 3 phr to 6 phr.

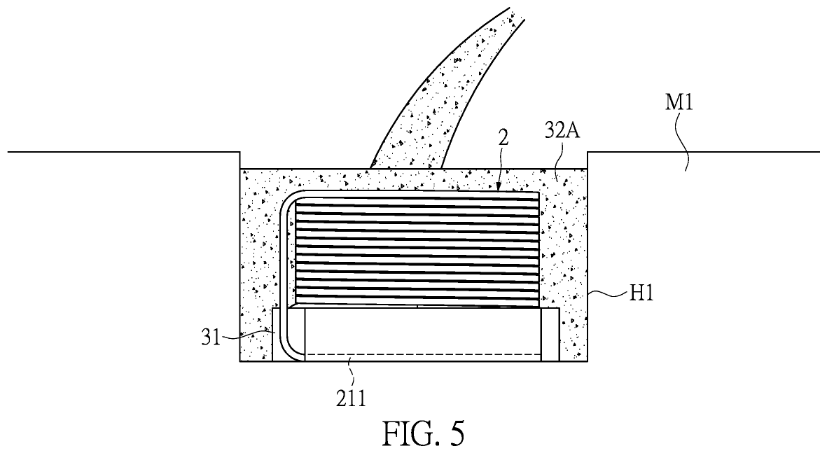

Referring to FIGS. 5 to 7, in steps of manufacturing the composite inductor of the first embodiment, the coil structure 2 is assembled on the first magnetic body 31 that is pre-formed. The magnetic body 31 is used as a magnetic substrate. The mounting surface 31a of the magnetic body 31 faces the coil main body 20, and the magnetic body 31 is engaged between the first bending section 210 and the second bending section 220.

Referring to FIG. 5, the magnetic body 31 and the coil structure 2 that are assembled together are placed in a mold cavity H1 of a mold M1. Subsequently, powder 32A for forming the second magnetic body 32 is filled in the mold cavity H1. The powder 32A includes the magnetic powder and the binder material.

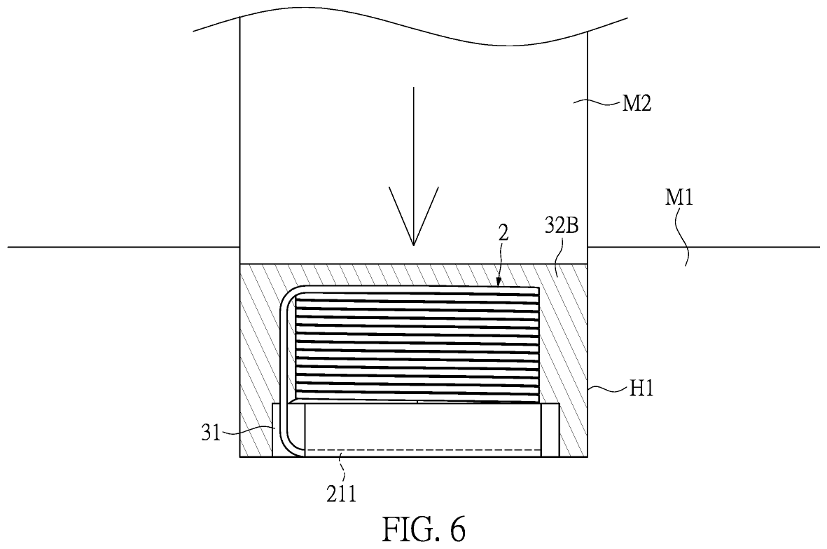

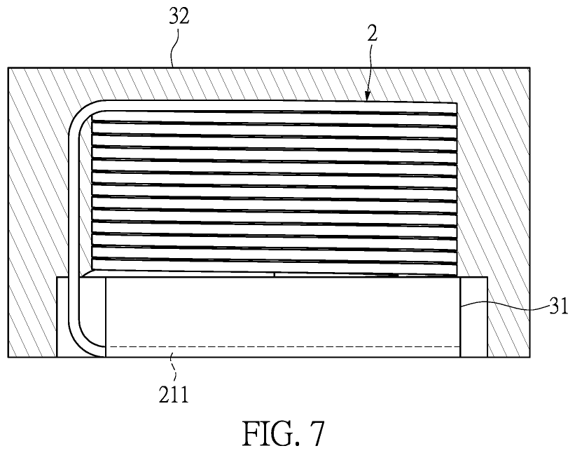

Referring to FIG. 6, the coil structure 2 and the first magnetic body 31 are covered by the powder 32A, and the powder 32A filled in the mold cavity H1 is stamped by using a stamping tool M2, such that an initial packaging body 32B can be formed in the mold cavity H1. By having pressure applied by the stamping tool M2, the powder 32A is compressed to fill an interval between the coil structure 2 and the first magnetic body 31. Referring to FIG. 7, after being hot-pressed at a temperature below 220° C., the initial packaging body 32B can be taken out from the mold M1.

In the manufacturing method in the first embodiment, after being taken out from the mold M1, the initial packaging body 32B can further undergo a heat treatment, such as a curing and baking treatment, so that the initial packaging body 32B is further cured to form the magnetic packaging structure 3. The magnetic packaging structure 3 contains the first magnetic body 31 and the second magnetic body 32, and a part of the magnetic packaging structure 3 is filled in the through hole 20h of the coil main body 20.

Specifically, the second magnetic body 32 is disposed on the first magnetic body 31. The coil structure 2 is embedded in the magnetic packaging structure 3. In the first embodiment, the first magnetic body 31 does not have a pillar part, so that a part of the second magnetic body 32 is filled in the through hole 20h. Specifically, based on a total thickness of the magnetic packaging structure 3 being 100%, a thickness h1 of the first magnetic body 31 is 16.7% (⅙), and a thickness h2 of the second magnetic body 32 is 83.3% (⅚).

A material used for forming the second magnetic body 32 includes a magnetic powder and a binder material. The magnetic powder includes at least one of a crystalline magnetic metal powder and an amorphous magnetic metal powder.

Specifically, the magnetic powder includes one of iron, iron-nickel alloys, iron-cobalt alloys, iron-silicon alloys, iron-vanadium alloys, iron-silicon-chromium alloys, iron-silicon-aluminum alloys, iron-cobalt-vanadium alloys, iron-based amorphous alloys, iron-based nanocrystalline alloys, nickel-zinc ferrite, nickel-copper-zinc ferrite, and manganese-zinc ferrite. The binder material can be an epoxy resin, a polysiloxane resin, an acrylic resin, a phenolic resin, or a polyvinyl alcohol.

By mixing the magnetic powders that have different particle sizes, the relative magnetic permeability and a saturation magnetic field strength of a magnetic body can be adjusted. Specific components of the magnetic body are listed as in Table 1. Specifically, the material for forming the second magnetic body 32 includes two types of magnetic powder, i.e., a first magnetic powder and a second magnetic powder. A median diameter of the first magnetic powder ranges from 1 μm to 5 μm. A median diameter of the second magnetic powder ranges from 10 μm to 30 μm.

In the first embodiment, the material for forming the second magnetic body 32 includes carbonyl iron powder that has a median diameter ranging from 1 μm to 2 μm and iron-based nanocrystalline alloy powder that has a median diameter ranging from 14 μm to 16 μm (preferably 15 μm). A weight ratio of the carbonyl iron powder to the iron-based nanocrystalline alloy powder ranges from 10:90 to 30:70. Based on a total weight of the magnetic powder being 100 phr, an amount of the binder material is 4 phr.

By selection of the materials and controlling particle size of the magnetic powder, a relative magnetic permeability of the second magnetic body 32 (ranging from 25 to less than 30) is higher than that of the first magnetic body 31 (ranging from 20 to less than 25). A saturated magnetic field strength of the first magnetic body 31 (ranging from 170 Oe to 215 Oe) is higher than that of the second magnetic body 32 (ranging from 140 Oe to less than 170 Oe).

In the present disclosure, the magnetic packaging structure 3 contains at least two kinds of magnetic bodies that have different relative magnetic permeability (the first magnetic body 31 and the second magnetic body 32). In the present disclosure, the relative magnetic permeability of the second magnetic body 32 is higher than that of the first magnetic body 31. By using various kinds of magnetic bodies, the saturation current and DC resistance of the composite inductor Z1 can be adjusted to meet application requirements.

In addition, the magnetic packaging structure 3 can further include an insulation layer 37. An outer surface of the magnetic packaging structure 3 is covered by the insulation layer 37.

TABLE 1

| | First | Second | Third | Fourth | Fifth | Sixth |
|---|---|---|---|---|---|---|
| | magnetic | magnetic | magnetic | magnetic | magnetic | magnetic |
| | body | body | body | body | body | body |
| First magnetic | Carbonyl | Carbonyl | Carbonyl | Iron-silicon- | Iron-nickel | Iron-nickel |
| powder | iron powder | iron powder | iron powder | chromium | alloy powder | alloy powder |
| | | | | alloy powder | | |
| Median diameter | 4 to 5 | 1 to 2 | 4 to 5 | 1 to 3 | 1 to 2 | 1 to 2 |
| of first magnetic | | | | | | |
| powder (μm) | | | | | | |
| Second magnetic | — | Iron-based | Iron-based | Iron-silicon- | Iron-based | Iron-based |
| powder | | nano- | nano- | chromium | nano- | nano- |
| | | crystalline | crystalline | alloy powder | crystalline | crystalline |
| | | alloy powder | alloy powder | | alloy powder | alloy powder |
| Median diameter | — | 14 to 16 | 14 to 16 | 14 to 16 | 24 to 26 | 14 to 16 |
| of second magnetic | | | | | | |
| powder (μm) | | | | | | |
| Weight ratio of | — | 10:90 to | 20:80 to | 5:95 to | 40:60 to | 50:50 to |
| first magnetic | | 30:70 | 50:50 | 20:80 | 10:90 | 90:10 |
| powder to second | | | | | | |
| magnetic powder | | | | | | |
| Relative magnetic | 20 to 25 | 25 to 30 | 30 to 35 | 45 to 60 | 40 to 45 | 35 to 40 |
| permeability | | | | | | |
| Saturated magnetic | 170 to | 140 to | 115 to | 60 to 90 | 90 to | 100 to |
| field strength (Oe) | 215 | 170 | 140 | | 100 | 115 |

### Second Embodiment

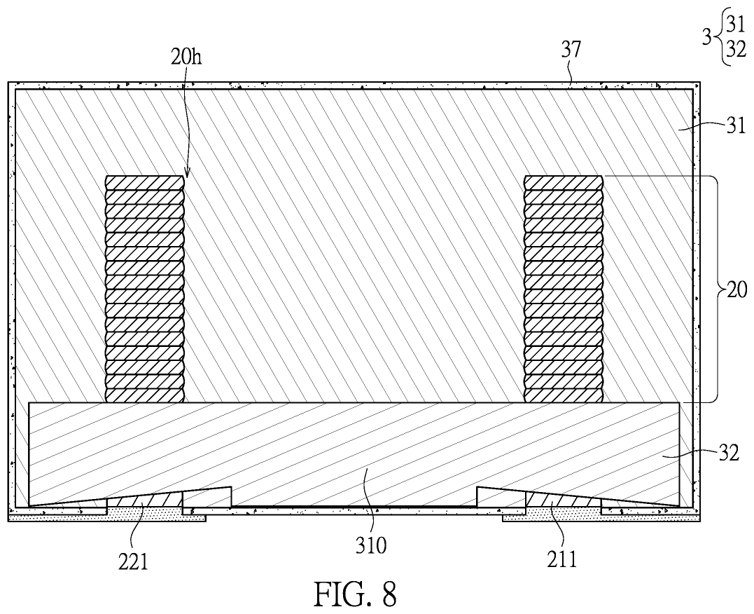

Referring to FIG. 8, the composite inductor in a second embodiment of the present disclosure includes the coil structure 2 and the magnetic packaging structure 3 similar to those in the first embodiment. In the second embodiment, the magnetic packaging structure 3 contains the first magnetic body 31 and the second magnetic body 32, that are horizontally stacked on each other.

The composite inductor in the second embodiment is similar to the composite inductor in the first embodiment. The difference is that the coil structure 2 is assembled on the second magnetic body 32, and the first magnetic body 31 is disposed on the second magnetic body 32, such that the coil structure 2 can be embedded in the magnetic packaging structure 3. In the second embodiment, the second magnetic body 32 is used as a magnetic substrate, and the second magnetic body 32 does not have a pillar part, such that a part of the first magnetic body 31 is filled in the through hole 20h.

Specifically, based on a total thickness of the magnetic packaging structure 3 being 100%, a thickness h1 of the first magnetic body 31 is 83.3% (⅚), and a thickness h2 of the second magnetic body 32 is 16.7% (⅙).

The first magnetic body 31 and the second magnetic body 32 used in the second embodiment are similar to those used in the first embodiment, and are not reiterated herein.

### Third Embodiment

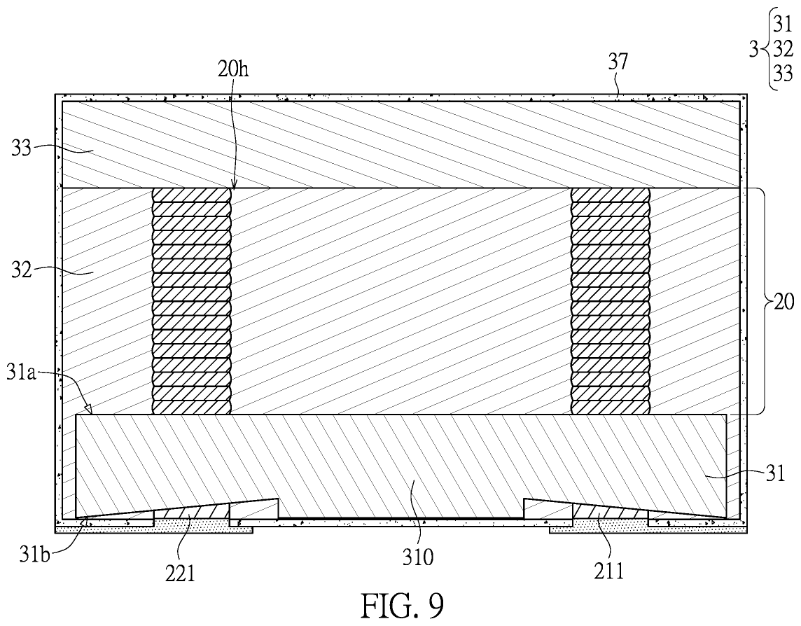

Referring to FIG. 9, the composite inductor Z1 in a third embodiment of the present disclosure includes the coil structure 2 and the magnetic packaging structure 3 similar to those in the first embodiment. In the third embodiment, the magnetic packaging structure 3 contains the first magnetic body 31, the second magnetic body 32, and a third magnetic body 33 that are horizontally and sequentially stacked on each other.

The composite inductor in the third embodiment is similar to the composite inductor in the first embodiment. The difference is that the magnetic packaging structure 3 further includes the third magnetic body 33.

The coil structure 2 is assembled on the first magnetic body 31. The second magnetic body 32 and the third magnetic body 33 are disposed on the first magnetic body 31, such that the coil structure 2 can be embedded in the magnetic packaging structure 3.

The second magnetic body 32 is disposed between the first magnetic body 31 and the third magnetic body 33. In the third embodiment, the first magnetic body 31 does not have a pillar part, so that a part of the second magnetic body 32 and a part of the third magnetic body 33 are filled in the through hole 20h. In addition, horizontal levels of a top surface of the second magnetic body 32 inside and outside of the through hole 20h are the same.

Specifically, based on a total thickness of the magnetic packaging structure 3 being 100%, a thickness h1 of the first magnetic body 31 is 16.7% (⅙), a thickness h2 of the second magnetic body 32 is 41.65% ( 5/12), and a thickness h3 of the third magnetic body 33 is 41.65% ( 5/12).

A material used for forming the third magnetic body 33 includes carbonyl iron powder that has a median diameter ranging from 4 μm to 5 μm and an iron-based nanocrystalline alloy powder that has a median diameter ranging from 14 μm to 16 μm (preferably 15 μm). A weight ratio of the carbonyl iron powder to the iron-based nanocrystalline alloy powder ranges from 20:80 to 50:50. Based on the total weight of the magnetic powder being 100 phr, the amount of the binder material is 4 phr.

By selection of the materials and controlling particle size of the magnetic powder, a relative magnetic permeability of the third magnetic body 33 (ranging from 30 to less than 35) is higher than that of the second magnetic body 32 (ranging from 25 to less than 30) and that of the first magnetic body 31 (ranging from 20 to less than 25). A saturated magnetic field strength of the third magnetic body 33 (ranging from 115 Oe to less than 140 Oe) is lower than that of the second magnetic body 32 (ranging from 140 Oe to less than 170 Oe) and that of the first magnetic body 31 (ranging from 170 Oe to 215 Oe).

The first magnetic body 31 and the second magnetic body 32 used in the third embodiment are similar to those used in the first embodiment, and are not reiterated herein.

When manufacturing the composite inductor in the third embodiment, the coil structure 2 is assembled on the first magnetic body 31 that is pre-formed, and is then put into a mold cavity. Materials for forming the second magnetic body 32 and the third magnetic body 33 are sequentially filled in the mold cavity, such that the coil structure 2 can be embedded in the magnetic packaging structure 3 to form a semi-finished product. Subsequently, the semi-finished product is hot-pressed at a temperature of below 220° C. to form the composite inductor.

### Fourth Embodiment

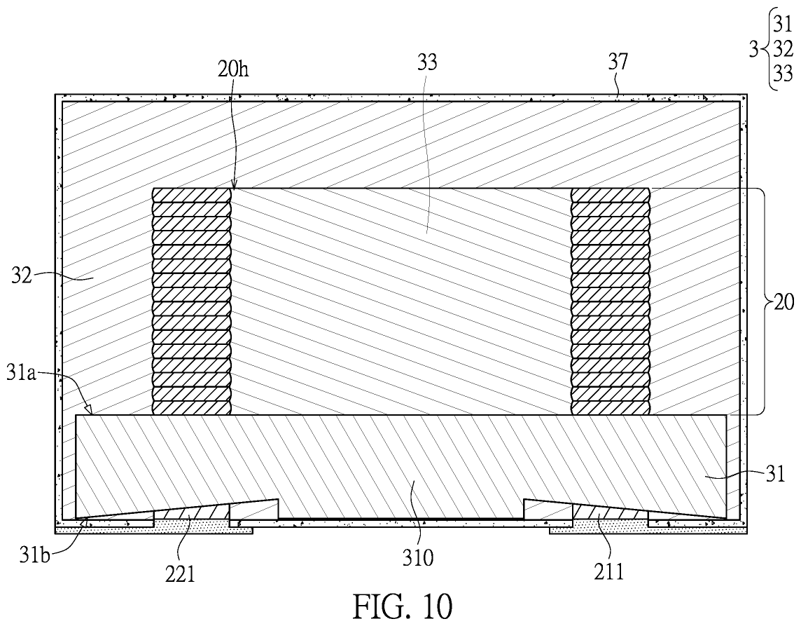

Referring to FIG. 10, the composite inductor in a fourth embodiment of the present disclosure includes the coil structure 2 and the magnetic packaging structure 3 similar to those in the first embodiment. In the fourth embodiment, the magnetic packaging structure 3 contains the first magnetic body 31, the second magnetic body 32, and the third magnetic body 33.

The composite inductor in the fourth embodiment is similar to the composite inductor in the first embodiment. The difference is that the magnetic packaging structure 3 further includes the third magnetic body 33.

The third magnetic body 33 is disposed in the through hole 20h. A top of the third magnetic body 33 and a top surface of the top turn of the coil structure 2 are at the same horizontal level. The third magnetic body 33 has functions that are similar to those of the pillar part.

Specifically, based on a total thickness of the magnetic packaging structure 3 being 100%, a thickness h1 of the first magnetic body 31 is 16.7% (⅙), and a thickness h2 of the second magnetic body 32 is 83.3% (⅚).

The first magnetic body 31, the second magnetic body 32, and the third magnetic body 33 used in the fourth embodiment are similar to those used in the third embodiment, and are not reiterated herein.

When manufacturing the composite inductor in the fourth embodiment, the first magnetic body 31 is pre-formed to act as a magnetic substrate. The coil structure 2 is disposed on the first magnetic body 31, and then is put into a mold cavity. The pre-formed third magnetic body 33 is disposed in the through hole 20h, and then the material used for forming the second magnetic body 32 is filled in the mold cavity, such that the coil structure 2 can be embedded in the magnetic packaging structure 3 and a semi-finished product can be therefore formed. Subsequently, the semi-finished product is hot-pressed at a temperature of below 220° C. to form the composite inductor.

### Fifth Embodiment

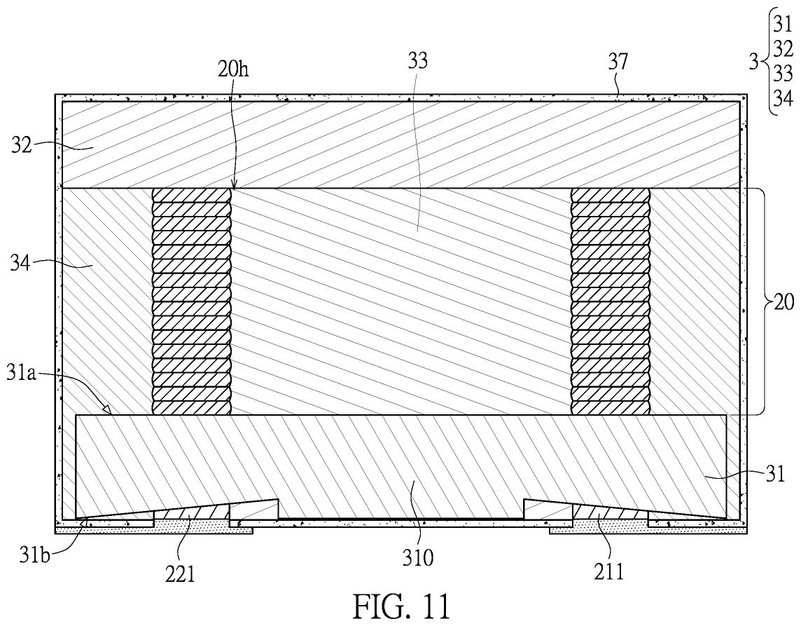

Referring to FIG. 11, the composite inductor in a fifth embodiment of the present disclosure includes the coil structure 2 and the magnetic packaging structure 3 similar to those in the first embodiment. In the fifth embodiment, the magnetic packaging structure 3 contains the first magnetic body 31, the second magnetic body 32, the third magnetic body 33, and a fourth magnetic body 34.

The composite inductor in the fifth embodiment is similar to the composite inductor in the fourth embodiment. The difference is that the magnetic packaging structure 3 further includes the fourth magnetic body 34. The fourth magnetic body 34 is horizontally disposed between the first magnetic body 31 and the second magnetic body 32, but not disposed in the through hole 20h.

Specifically, based on a total thickness of the magnetic packaging structure 3 being 100%, the thickness h1 of the first magnetic body 31 is 16.7% (⅙), the thickness h2 of the second magnetic body 32 is 16.7% (⅙), and a thickness h4 of the fourth magnetic body 34 is 66.6% (⅔).

A material used for forming the fourth magnetic body 34 includes iron-silicon-chromium alloy powder that has a median diameter ranging from 1 μm to 3 μm and iron-silicon-chromium alloy powder that has a median diameter ranging from 14 μm to 16 μm. A weight ratio of the iron-silicon-chromium alloy powder having the median diameter ranging from 1 μm to 3 μm to the iron-silicon-chromium alloy powder having the median diameter ranging from 14 μm to 16 μm ranges from 5:95 to 20:80. Based on the total weight of the magnetic powder being 100 phr, the amount of the binder material is 4 phr.

By selection of the materials and controlling a particle size of the magnetic powder, a relative magnetic permeability of the fourth magnetic body 34 (45 to 60) is higher than that of the third magnetic body 33 (30 to less than 35), that of the second magnetic body 32 (25 to less than 30), and that of the first magnetic body 31 (20 to less than 25). A saturated magnetic field strength of the fourth magnetic body 34 (ranging from 60 Oe to less than 90 Oe) is lower than the saturated magnetic field strength of the third magnetic body 33 (ranging from 115 Oe to less than 140 Oe), that of the second magnetic body 32 (ranging from 140 Oe to less than 170 Oe), and that of the first magnetic body 31 (ranging from 170 Oe to 215 Oe).

The first magnetic body 31, the second magnetic body 32, and the third magnetic body 33 used in the fifth embodiment are similar to those used in the fourth embodiment, and are not reiterated herein.

### Sixth Embodiment

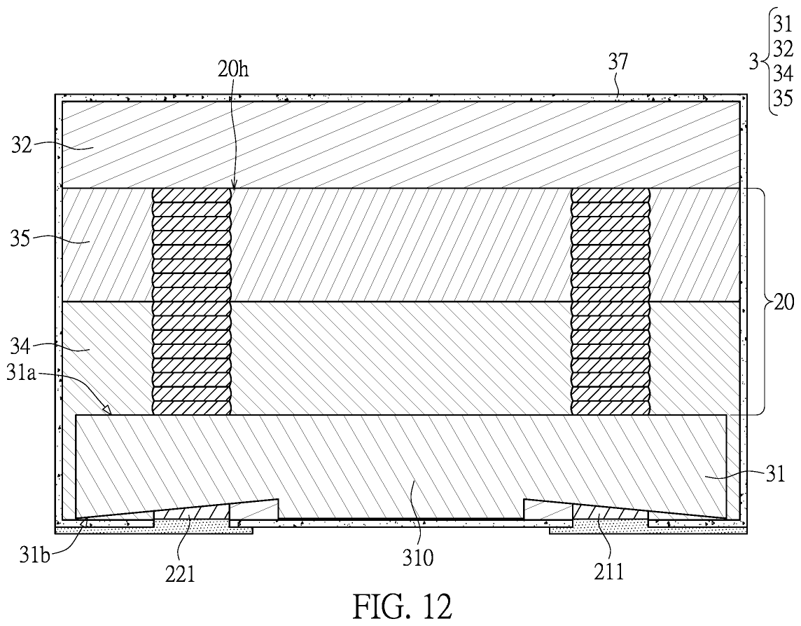

Referring to FIG. 12, the composite inductor in a sixth embodiment of the present disclosure includes the coil structure 2 and the magnetic packaging structure 3 similar to those in the first embodiment. In the sixth embodiment, the magnetic packaging structure 3 contains the first magnetic body 31, the fourth magnetic body 34, a fifth magnetic body 35, and the second magnetic body 32 that are sequentially and horizontally disposed on each other.

The composite inductor in the sixth embodiment is similar to the composite inductor in the first embodiment. The difference is that the magnetic packaging structure 3 further includes the fourth magnetic body 34 and the fifth magnetic body 35. The fourth magnetic body 34 and the fifth magnetic body 35 are disposed between the first magnetic body 31 and the second magnetic body 32. In the sixth embodiment, the first magnetic body 31 does not have a pillar part. Therefore, a part of the fourth magnetic body 34 is filled in the through hole 20h, and horizontal levels of the fourth magnetic body 34 inside and outside the through hole 20h are the same. A part of the fifth magnetic body 35 is filled in the through hole 20h, and horizontal levels of the fifth magnetic body 35 inside and outside the through hole 20h are the same. Accordingly, the fourth magnetic body 34 and the fifth magnetic body 35 can have similar functions to the pillar part.

Specifically, based on a total thickness of the magnetic packaging structure 3 being 100%, the thickness h1 of the first magnetic body 31 is 16.7% (⅙), the thickness h4 of the fourth magnetic body 34 is 33.3% (⅓), a thickness h5 of the fifth magnetic body 35 is 33.3% (⅓), and the thickness h2 of the second magnetic body 32 is 16.7% (⅙).

A material used for forming the fifth magnetic body 35 includes iron-nickel alloy powder that has a median diameter ranging from 1 μm to 2 μm and iron-based nanocrystalline alloy powder that has a median diameter ranging from 24 μm to 26 μm (preferably 25 μm). A weight ratio of the iron-nickel alloy powder to the iron-based nanocrystalline alloy powder ranges from 40:60 to 10:90. Based on the total weight of the magnetic powder being 100 phr, the amount of the binder material is 4 phr.

By selection of the materials and controlling particle size of the magnetic powder, a relative magnetic permeability of the fifth magnetic body 35 (ranging from 40 to less than 45) is higher than that of the second magnetic body 32 (ranging from 25 to less than 30) and that of the first magnetic body 31 (ranging from 20 to less than 25). However, a relative magnetic permeability of the fifth magnetic body 35 (ranging from 40 to less than 45) is lower than that of the fourth magnetic body 34 (ranging from 45 to 60). A saturated magnetic field strength of the fifth magnetic body 35 (ranging from 90 Oe to less than 100 Oe) is lower than that of the second magnetic body 32 (ranging from 140 Oe to less than 170 Oe) and that of the first magnetic body 31 (ranging from 170 Oe to 215 Oe). However, a saturated magnetic field strength of the fifth magnetic body 35 (ranging from 90 Oe to less than 100 Oe) is higher than that of the fourth magnetic body 34 (ranging from 60 Oe to less than 90 Oe).

The first magnetic body 31, the second magnetic body 32, and the fourth magnetic body 34 used in the sixth embodiment are similar to those used in the fifth embodiment, and are not reiterated herein.

### Seventh Embodiment

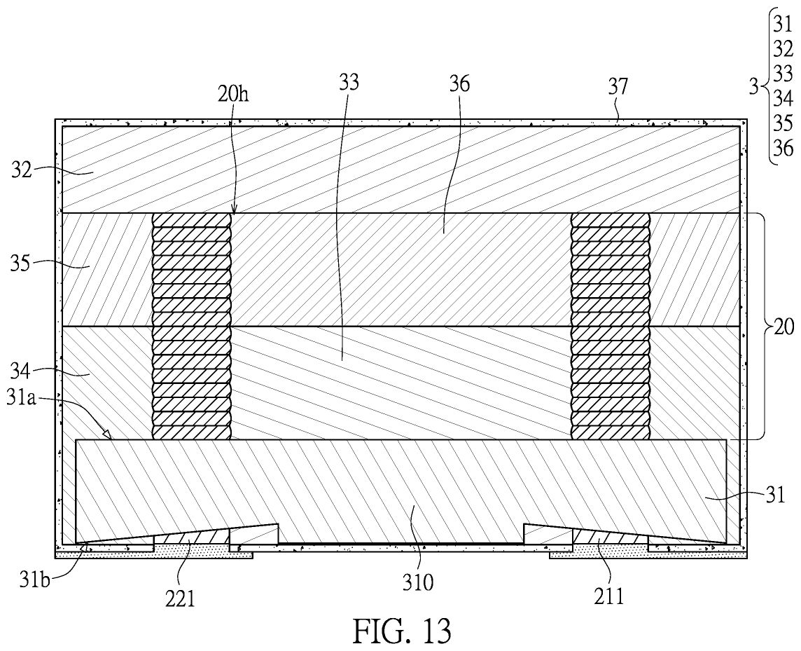

Referring to FIG. 13, the composite inductor in a seventh embodiment of the present disclosure includes the coil structure 2 and the magnetic packaging structure 3 similar to those in the first embodiment. In the seventh embodiment, the magnetic packaging structure 3 contains the first magnetic body 31, the second magnetic body 32, the third magnetic body 33, the fourth magnetic body 34, the fifth magnetic body 35, and a sixth magnetic body 36.

The composite inductor in the seventh embodiment is similar to the composite inductor in the sixth embodiment. The difference is that the magnetic packaging structure 3 further includes the third magnetic body 33 and the sixth magnetic body 36. The third magnetic body 33 is filled in the through hole 20h, and the sixth magnetic body 36 is filled in the through hole 20h. The third magnetic body 33 is disposed between the first magnetic body 31 and the sixth magnetic body 36. A horizontal level of the fourth magnetic body 34 near the coil structure 2 is the same with a horizontal level of the third magnetic body 33 in the through hole 20h. A horizontal level of the fifth magnetic body 35 near the coil structure 2 is the same with a horizontal level of the sixth magnetic body 36 in the through hole 20h.

Specifically, based on a total thickness of the magnetic packaging structure 3 being 100%, the thickness h1 of the first magnetic body 31 is 16.7% (⅙), the thickness h4 of the fourth magnetic body 34 is 33.3% (⅓), a thickness h5 of the fifth magnetic body 35 is 33.3% (⅓), and the thickness h2 of the second magnetic body 32 is 16.7% (⅙).

A material used for forming the sixth magnetic body 36 includes iron-nickel alloy powder that has a median diameter ranging from 1 μm to 2 μm and iron-based nanocrystalline alloy powder that has a median diameter ranging from 14 μm to 16 μm. A weight ratio of the iron-nickel alloy powder to the iron-based nanocrystalline alloy powder ranges from 50:50 to 90:10. Based on the total weight of the magnetic powder being 100 phr, the amount of the binder material is 4 phr.

By selection of the materials and controlling particle size of the magnetic powder, a relative magnetic permeability of the sixth magnetic body 36 (ranging from 35 to less than 40) is higher than that of the third magnetic body 33 (ranging from 30 to less than 35), that of the second magnetic body 32 (ranging from 25 to less than 30) and that of the first magnetic body 31 (ranging from 20 to less than 25). However, a relative magnetic permeability of the sixth magnetic body 36 (ranging from 35 to less than 40) is lower than that of the fifth magnetic body 35 (ranging from 40 to less than 45) and that of the fourth magnetic body 34 (ranging from 45 to 60). A saturated magnetic field strength of the sixth magnetic body 36 (ranging from 100 Oe to less than 115 Oe) is lower than that of the third magnetic body 33 (ranging from 115 Oe to less than 140 Oe), that of the second magnetic body 32 (ranging from 140 Oe to less than 170 Oe), and that of the first magnetic body 31 (ranging from 170 Oe to 215 Oe). However, a saturated magnetic field strength of the sixth magnetic body 36 (ranging from 100 Oe to less than 115 Oe) is higher than that of the fifth magnetic body 35 (ranging from 90 Oe to less than 100 Oe) and that of the fourth magnetic body 34 (ranging from 60 Oe to less than 90 Oe).

The first magnetic body 31, the second magnetic body 32, the fourth magnetic body 34, and the fifth magnetic body 35 used in the seventh embodiment are similar to those used in the fifth embodiment, and the third magnetic body 33 used in the seventh embodiment are similar to the third magnetic body 33 used in the third embodiment, and are not reiterated herein.

When manufacturing the composite inductor in the seventh embodiment, the first magnetic body 31 formed beforehand is disposed in the mold cavity. The coil structure 2, the pre-formed third magnetic body 33, and the pre-formed sixth magnetic body 36 are disposed on the first magnetic body 31. The pre-formed third magnetic body 33 and the sixth magnetic body 36 are disposed in the through hole 20h of the coil structure 2, and then the materials used for forming the fourth magnetic body 34, the fifth magnetic body 35, and the second magnetic body 32 are filled in the mold cavity to form a semi-finished product. Subsequently, the semi-finished product is hot-pressed at a temperature of below 220° C. to form the composite inductor.

### Experimental Data

In order to compare the composite inductor of the present disclosure with a conventional inductor, a single magnetic body (i.e., the first magnetic body 31 or the second magnetic body 32) is used as the magnetic packaging structure 3 in Comparative Examples 1 and 2 (C1 and C2). Specifically, the magnetic packaging structure 3 in Comparative Example 1 contains only the first magnetic body 31, and the magnetic packaging structure 3 in Comparative Example 2 contains only the second magnetic body 32. The composite inductors in Examples 1 to 7 (E1 to E7) are respectively manufactured according to the first embodiment to the seventh embodiment.

Inductances, saturated currents, and DC resistances of the composite inductors in Examples 1 to 7 and the inductors in Comparative Examples 1 and 2 are measured and listed in Table 2. Number of the turns of the coil main body 20 and the magnetic body that are used in Examples 1 to 7 and Comparative Examples 1 and 2 are also listed in Table 2. The composite inductors in Examples 1 to 7 and the inductors in Comparative Examples 1 and 2 have the same size (length/width/height being 2.5 mm/2.0 mm/1.2 mm).

TABLE 2

| | C1 | C2 | E1 | E2 | E3 | E4 | E5 | E6 | E7 |
|---|---|---|---|---|---|---|---|---|---|
| First magnetic | V | — | V | V | V | V | V | V | V |
| body | | | | | | | | | |
| Second magnetic | — | V | V | V | V | V | V | V | V |
| body | | | | | | | | | |
| Third magnetic | — | — | — | — | V | V | V | — | V |
| body | | | | | | | | | |
| Fourth magnetic | — | — | — | — | — | — | V | V | V |
| body | | | | | | | | | |
| Fifth magnetic | — | — | — | — | — | — | — | V | V |
| body | | | | | | | | | |
| Sixth magnetic | — | — | — | — | — | — | — | — | V |
| body | | | | | | | | | |
| Ring number | 7 | 7 | 6 | 6 | 5 | 5 | 4 | 4 | 4 |
| Inductance (μH) | 0.39 | 0.49 | 0.47 | 0.47 | 0.47 | 0.47 | 0.47 | 0.47 | 0.47 |
| Saturated | 6 | 3 | 3 | 4.5 | 2.8 | 2.8 | 1.8 | 2.8 | 1.6 |
| current (A) | | | | | | | | | |
| DC resistance | 30 | 30 | 28 | 30 | 26 | 24 | 22 | 20 | 18 |
| (mΩ) | | | | | | | | | |

According to results of Example 1 and Comparative Example 2, under the condition of having the same saturated current, the composite inductor containing two kinds of magnetic bodies of the present disclosure shows a lower DC resistance. According to results of Example 2 and Comparative Example 1, under the condition of having the same DC resistance, the composite inductor containing two kinds of magnetic bodies of the present disclosure shows a lower saturated current.

According to results of Examples 1 to 7, electrical characteristics of the composite inductor can be adjusted by using different magnetic bodies and structural designs to meet various requirements. For example, when the inductance of the composite inductor ranges from 0.40 pH to 0.50 pH, the DC resistance of the composite inductor of the present disclosure can range from 15 mΩ to 30 mΩ (preferably from 18 mΩ to 30 mΩ), and the saturated current of the composite inductor of the present disclosure can range from 1.2 A to 5.0 A (preferably from 1.6 A to 4.5 A).

More specifically, when one part of the magnetic body is surrounded by the coil structure 2 (i.e., the part of the magnetic body is used as the pillar part) and any magnetic bodies are horizontally disposed between the first magnetic body 31 and the second magnetic body 32 (e.g., in Examples 5 and 7), the composite inductor of the present disclosure can show low saturated current and low DC resistance.

### Eighth Embodiment

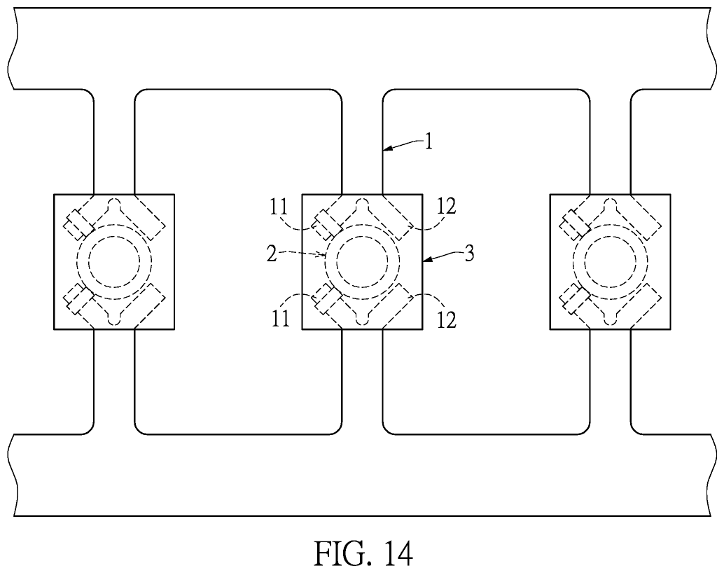

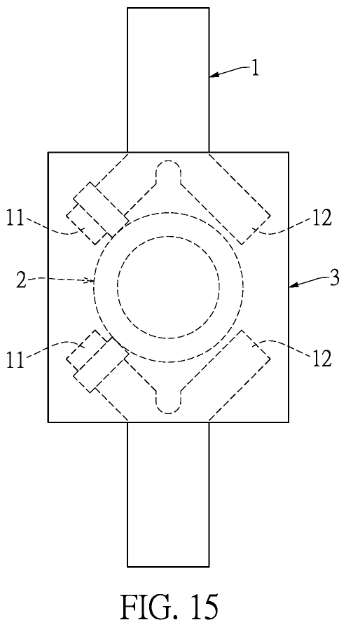

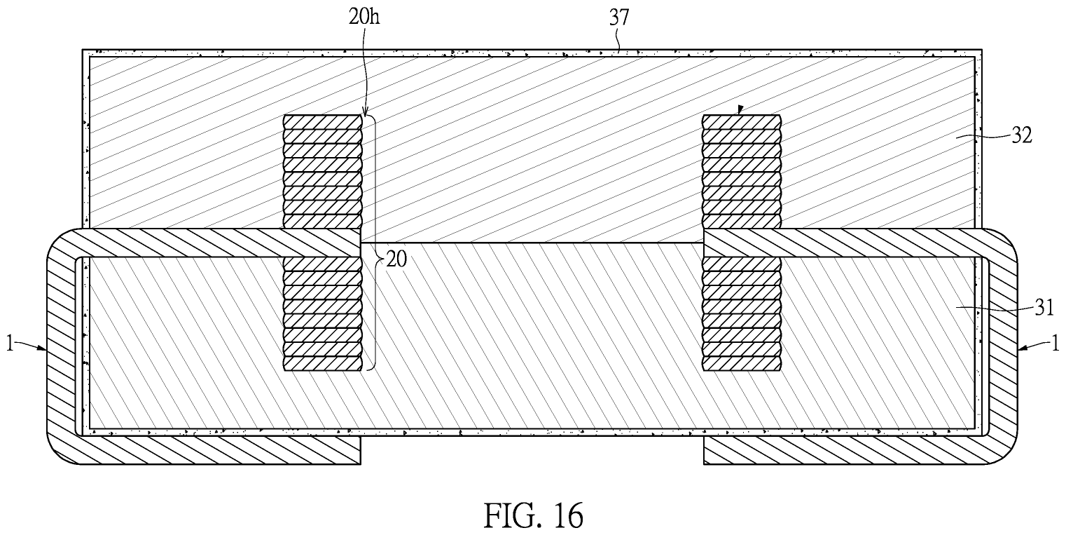

Referring to FIGS. 14 to 16, the composite inductor can further include a conductive frame 1. The coil structure 2 is disposed on the conductive frame 1 by welding, such that the conductive frame 1 can be used for electrical connection between the coil structure 2 and an external circuit.

Specifically, the conductive frame 1 is a Y-shaped conductive frame. Two connection ends 11, 12 of the conductive frame 1 can be connected with the coil main body 20. However, the conductive frame 1 is not limited to be Y-shaped, and the conductive frame 1 can be in other shapes, such as a linear shape or other shapes. When the coil structure 2 includes multiple ones of the coil main body 20, an electrical current direction of the composite inductor can be changed by connecting the coil structure 2 with different connection ends 11, 12. In addition, the coil structure 2 can be welded on the connection end 11 of the conductive frame 1 after the conductive frame 1 has undergone a tin plating process. The tin plating process includes plating a layer of tin on the conductive frame 1 to enhance the welding effect between the conductive frame 1 and the coil structure 2.

The coil structure 2 is completely encapsulated by the magnetic packaging structure 3. The magnetic packaging structure 3 contains two kinds or more than two kinds of magnetic bodies, such as the aforementioned first magnetic body 31 and the second magnetic body 32. The conductive frame 1 is partially encapsulated by the magnetic packaging structure 3. The part of the conductive frame 1 that is not encapsulated by the magnetic packaging structure 3 extends along an outer surface of the magnetic packaging structure 3 and then bends toward a bottom of the magnetic packaging structure 3 so as to be connected with an external circuit.

In steps of manufacturing the composite inductor in the eighth embodiment, a plate having multiple ones of the conductive frame 1 is used, and the coil structure 2 is welded on the connection end 11. Similar to aforementioned embodiments, the conductive frame 1 that is assembled to the coil structure 2 is placed in the mold cavity of the mold, and the powders used for forming the magnetic body is filled in the mold cavity. The powder includes magnetic powder and binder material. After being stamped, hot-pressed, and heat-treated, the powders can form the magnetic packaging structure 3. It should be noted that the magnetic packaging structure 3 in the eighth embodiment contains the first magnetic body 31 and the second magnetic body 32. Based on a total thickness of the magnetic packaging structure 3 being 100%, a thickness h1 of the first magnetic body 31 is 16.7% (⅙), and a thickness h2 of the second magnetic body 32 is 83.3% (⅚).

After forming the magnetic packaging structure 3, the conductive frame 1 can be cut from the plate. The exposed conductive frame 1 (i.e., the part of the exposed conductive frame 1 that is not encapsulated by the magnetic packaging structure 3) can be bent along the outer surface of the magnetic packaging structure 3 toward the bottom of the magnetic packaging structure 3, such that the composite inductor of the eighth embodiment is formed.

### Beneficial Effects of the Embodiments

In conclusion, in the composite inductor provided by the present disclosure, by virtue of “the magnetic packaging structure containing at least a first magnetic body and a second magnetic body,” and “based on a total thickness of the magnetic packaging structure being 100%, a thickness of each of the first magnetic body and the second magnetic body being higher than or equal to 16%,” electrical characteristics of the composite inductor can be enhanced or modified.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A composite inductor, comprising:
a coil structure having a through hole; and
a magnetic packaging structure containing at least a first magnetic body and a second magnetic body; wherein the coil structure is embedded in the magnetic packaging structure, and based on a total thickness of the magnetic packaging structure being 100%, a thickness of each of the first magnetic body and the second magnetic body is greater than or equal to 16%.

2. The composite inductor according to claim 1, wherein a relative magnetic permeability of the second magnetic body is higher than a relative magnetic permeability of the first magnetic body.

3. The composite inductor according to claim 2, wherein the first magnetic body is used as a magnetic substrate, and the second magnetic body is disposed on the first magnetic body.

4. The composite inductor according to claim 2, wherein the second magnetic body is used as a magnetic substrate, and the first magnetic body is disposed on the second magnetic body.

5. The composite inductor according to claim 2, wherein the relative magnetic permeability of the first magnetic body ranges from 20 to less than 25, and the relative magnetic permeability of the second magnetic body ranges from 25 to less than 30.

6. The composite inductor according to claim 3, wherein the magnetic packaging structure further contains a third magnetic body, and a relative magnetic permeability of the third magnetic body is higher than the relative magnetic permeability of the second magnetic body.

7. The composite inductor according to claim 6, wherein the second magnetic body is disposed between the first magnetic body and the third magnetic body.

8. The composite inductor according to claim 6, wherein the third magnetic body is surrounded by the coil structure and is disposed in the through hole, and the third magnetic body is disposed between the first magnetic body and the second magnetic body.

9. The composite inductor according to claim 6, wherein the relative magnetic permeability of the third magnetic body ranges from 30 to less than 35.

10. The composite inductor according to claim 8, wherein the magnetic packaging structure further contains a fourth magnetic body, and a relative magnetic permeability of the fourth magnetic body is higher than the relative magnetic permeability of the third magnetic body.

11. The composite inductor according to claim 10, wherein the fourth magnetic body is disposed between the first magnetic body and the second magnetic body, and the coil structure is surrounded by the fourth magnetic body.

12. The composite inductor according to claim 10, wherein the relative magnetic permeability of the fourth magnetic body ranges from 45 to less than 60.

13. The composite inductor according to claim 3, wherein the magnetic packaging structure further contains a fourth magnetic body and a fifth magnetic body, a relative magnetic permeability of the fourth magnetic body is higher than a relative magnetic permeability of the fifth magnetic body, and the relative magnetic permeability of the fifth magnetic body is higher than the relative magnetic permeability of the second magnetic body.

14. The composite inductor according to claim 13, wherein the fourth magnetic body and the fifth magnetic body are disposed between the first magnetic body and the second magnetic body.

15. The composite inductor according to claim 14, wherein the fourth magnetic body is disposed between the fifth magnetic body and the first magnetic body.

16. The composite inductor according to claim 13, wherein the relative magnetic permeability of the fourth magnetic body ranges from 45 to less than 60, and the relative magnetic permeability of the fifth magnetic body ranges from 40 to less than 45.

17. The composite inductor according to claim 15, wherein the magnetic packaging structure further contains a third magnetic body and a sixth magnetic body, a relative magnetic permeability of the fifth magnetic body is higher than the relative magnetic permeability of the sixth magnetic body, and the relative magnetic permeability of the sixth magnetic body is higher than the relative magnetic permeability of the third magnetic body.

18. The composite inductor according to claim 17, wherein the third magnetic body and the sixth magnetic body are disposed in the through hole and surrounded by the coil structure, and the third magnetic body and the sixth magnetic body are disposed between the first magnetic body and the second magnetic body.

19. The composite inductor according to claim 17, wherein the third magnetic body is disposed between the first magnetic body and the sixth magnetic body.

20. The composite inductor according to claim 17, wherein the relative magnetic permeability of the third magnetic body ranges from 30 to less than 35, and the relative magnetic permeability of the sixth magnetic body ranges from 35 to less than 40.

21. The composite inductor according to claim 1, wherein the total thickness of the magnetic packaging structure is higher than or equal to 0.1 mm.

22. The composite inductor according to claim 1, wherein the magnetic packaging structure is integrally formed by compression molding.

23. The composite inductor according to claim 1, wherein a material used for forming the first magnetic body includes a magnetic powder and a binder material, the magnetic powder includes one of iron, iron-nickel alloys, iron-cobalt alloys, iron-silicon alloys, iron-vanadium alloys, iron-silicon-chromium alloys, iron-silicon-aluminum alloys, iron-cobalt-vanadium alloys, iron-based amorphous alloys, iron-based nanocrystalline alloys, nickel-zinc ferrite, nickel-copper-zinc ferrite, and manganese-zinc ferrite, and a median diameter of the magnetic powder ranges from 4 μm to 5 μm.

24. The composite inductor according to claim 1, wherein a material used for forming the second magnetic body includes a magnetic powder and a binder material, the magnetic powder includes at least two of iron, iron-nickel alloys, iron-cobalt alloys, iron-silicon alloys, iron-vanadium alloys, iron-silicon-chromium alloys, iron-silicon-aluminum alloys, iron-cobalt-vanadium alloys, iron-based amorphous alloys, iron-based nanocrystalline alloys, nickel-zinc ferrite, nickel-copper-zinc ferrite, and manganese-zinc ferrite, the magnetic powder includes a first magnetic powder that has a median diameter ranging from 1 μm to 2 μm and a second magnetic powder that has a median diameter ranging from 14 μm to 16 μm, and a weight ratio of the first magnetic powder to the second magnetic powder ranges from 10:90 to 30:70.

25. The composite inductor according to claim 6, wherein a material used for forming the third magnetic body includes a magnetic powder and a binder material, the magnetic powder includes at least two of iron, iron-nickel alloys, iron-cobalt alloys, iron-silicon alloys, iron-vanadium alloys, iron-silicon-chromium alloys, iron-silicon-aluminum alloys, iron-cobalt-vanadium alloys, iron-based amorphous alloys, iron-based nanocrystalline alloys, nickel-zinc ferrite, nickel-copper-zinc ferrite, and manganese-zinc ferrite, the magnetic powder includes a first magnetic powder that has a median diameter ranging from 4 μm to 5 μm and a second magnetic powder that has a median diameter ranging from 14 μm to 16 μm, and a weight ratio of the first magnetic powder to the second magnetic powder ranges from 20:80 to 50:50.

26. The composite inductor according to claim 13, wherein a material used for forming the fourth magnetic body includes a magnetic powder and a binder material, the magnetic powder includes at least two of iron, iron-nickel alloys, iron-cobalt alloys, iron-silicon alloys, iron-vanadium alloys, iron-silicon-chromium alloys, iron-silicon-aluminum alloys, iron-cobalt-vanadium alloys, iron-based amorphous alloys, iron-based nanocrystalline alloys, nickel-zinc ferrite, nickel-copper-zinc ferrite, and manganese-zinc ferrite, the magnetic powder includes a first magnetic powder that has a median diameter ranging from 1 μm to 3 μm and a second magnetic powder that has a median diameter ranging from 14 μm to 16 μm, and a weight ratio of the first magnetic powder to the second magnetic powder ranges from 5:95 to 20:80.

27. The composite inductor according to claim 13, wherein a material used for forming the fifth magnetic body includes a magnetic powder and a binder material, the magnetic powder includes at least two of iron, iron-nickel alloys, iron-cobalt alloys, iron-silicon alloys, iron-vanadium alloys, iron-silicon-chromium alloys, iron-silicon-aluminum alloys, iron-cobalt-vanadium alloys, iron-based amorphous alloys, iron-based nanocrystalline alloys, nickel-zinc ferrite, nickel-copper-zinc ferrite, and manganese-zinc ferrite, the magnetic powder includes a first magnetic powder that has a median diameter ranging from 1 μm to 3 μm and a second magnetic powder that has a median diameter ranging from 24 μm to 26 μm, and a weight ratio of the first magnetic powder to the second magnetic powder ranges from 40:60 to 10:90.

28. The composite inductor according to claim 17, wherein a material used for forming the sixth magnetic body includes a magnetic powder and a binder material, the magnetic powder includes at least two of iron, iron-nickel alloys, iron-cobalt alloys, iron-silicon alloys, iron-vanadium alloys, iron-silicon-chromium alloys, iron-silicon-aluminum alloys, iron-cobalt-vanadium alloys, iron-based amorphous alloys, iron-based nanocrystalline alloys, nickel-zinc ferrite, nickel-copper-zinc ferrite, and manganese-zinc ferrite, the magnetic powder includes a first magnetic powder that has a median diameter ranging from 1 μm to 2 μm and a second magnetic powder that has a median diameter ranging from 14 μm to 16 μm, and a weight ratio of the first magnetic powder to the second magnetic powder ranges from 50:50 to 90:10.

29. The composite inductor according to claim 1, further comprising a conductive frame electrically connected with the coil structure, wherein the conductive frame extends out of the magnetic packaging structure to be electrically connected with an external circuit.
